(19) United States
(12) Patent Application Publication
(10) Pub. No.: US 2014/0349503 A1
(43) Pub. Date: Nov. 27, 2014

(54) ASSISTING APPARATUS FOR UNPLUGGING RJ-45 CONNECTOR

(71) Applicants: HONG FU JIN PRECISION INDUSTRY (ShenZhen) CO., LTD, Shenzhen (CN); HON HAI PRECISION INDUSTRY CO., LTD., New Taipei (TW)

(72) Inventors: XIAO-GANG YIN, Shenzhen (CN); MENG-LIANG YANG, Shenzhen (CN); ZHENG-BING SONG, Shenzhen (CN)

(73) Assignees: HONG FU JIN PRECISION INDUSTRY (ShenZhen) CO., LTD, Shenzhen (CN); HON HAI PRECISION INDUSTRY CO., LTD., New Taipei (TW)

(21) Appl. No.: 14/279,503

(22) Filed: May 16, 2014

(30) Foreign Application Priority Data
May 22, 2013 (CN) 201310191610X

(51) Int. Cl. H01R 13/629

(52) U.S. Cl. CPC H01R 13/62933
USPC 439/296

(57) ABSTRACT

An assisting apparatus is provided to unplug a Registered Jack-45 (RJ-45) connector from a connector of an electronic device. The assisting apparatus includes an operation member. The operation member includes a pivot portion pivotably connected to a sidewall of the electronic device, a handle extending from the pivot portion, and an urging plate extending from the pivot portion and located above a latch of the RJ-45 connector engaging with the connector of the electronic device. The handle is operable to rotate the operation member to allow the urging plate to push the latch down, to make the latch disengage from the connector of the electronic device.

### FIELD

The present disclosure relates to an assisting apparatus for unplugging a Registered Jack-45 (RJ-45) connector.

### BACKGROUND

RJ-45 connectors are widely used in network communication. However, unplugging an RJ-45 connector manually from a connector of an electronic device can be difficult and inconvenient because of limited space for maneuvering.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the disclosed and described embodiments. Moreover, in the drawings, all the views are schematic, and like reference numerals designate corresponding parts throughout the several views.

FIG. 1 is an exploded, isometric view of an exemplary embodiment of an assisting apparatus together with an electronic device and a Registered Jack-45 (RJ-45) connector, wherein the assisting apparatus comprises an operation member and a connection member.

FIG. 2 is an enlarged view of the operation member of FIG. 1.

FIG. 3 is an enlarged view of the connection member of FIG. 1.

FIG. 4 is an assembled, isometric view of FIG. 1.

FIG. 5 is a front view of FIG. 4.

FIG. 6 is similar to FIG. 5, but shows another state of use.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

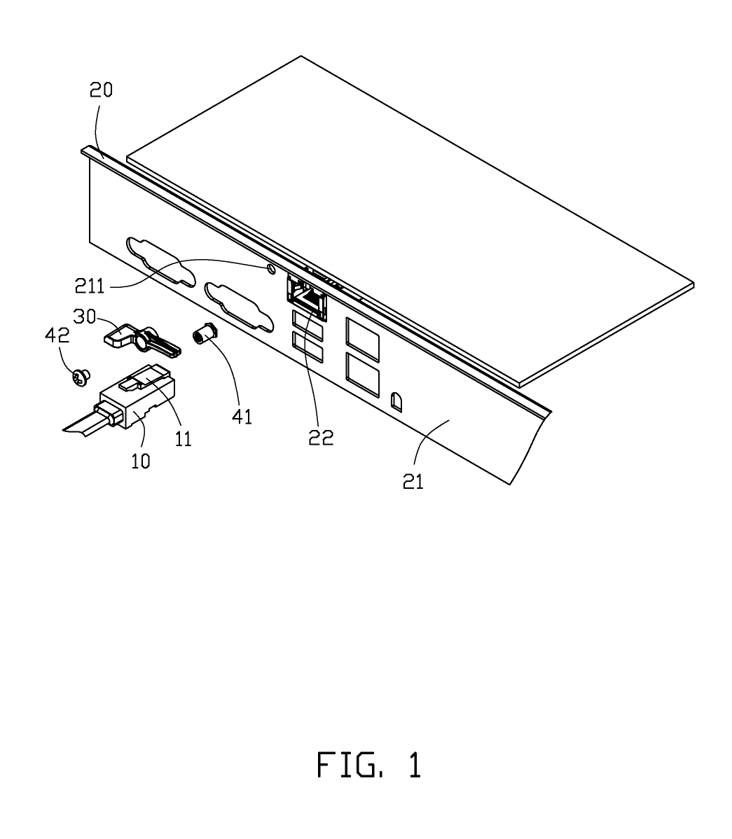

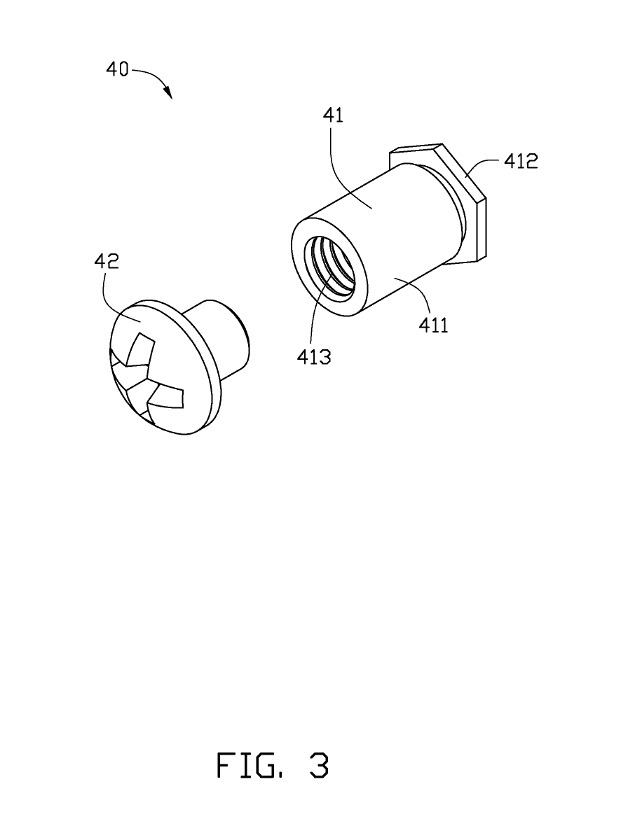

FIG. 1 illustrates an exemplary embodiment of an assisting apparatus for unplugging a Registered Jack-45 (RJ-45) connector 10 from an electronic device 20. The assisting apparatus comprises an operation member 30 and a connection member 40 (see FIG. 3).

The electronic device 20 comprises a sidewall 21. A connector 22 is mounted inside the electronic device 20 and is exposed through the sidewall 21. The sidewall 21 defines a mounting hole 211 near the connector 22.

The RJ-45 connector 10 is connected to the connector 22. A resilient latch 11 slantingly extends up and forward from a rear end of the RJ-45 connector 10 for engaging with the connector 22.

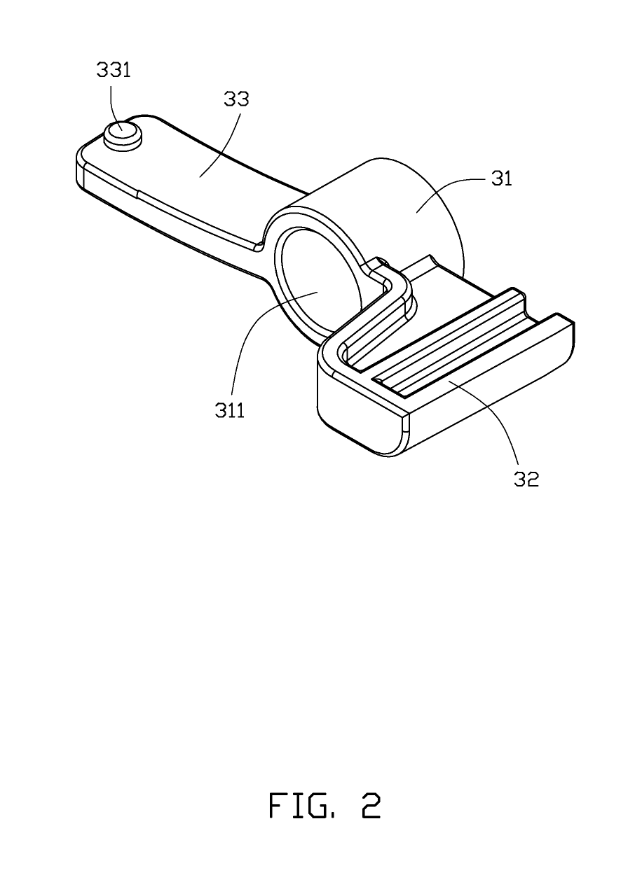

FIG. 2 illustrates the operation member 30 comprising a columnar pivot portion 31, a handle 32 extending from a circumference of the pivot portion 31, and an urging plate 33 extending from the circumference of the pivot portion 31 and opposite to the handle 32. The pivot portion 31 axially defines a pivot hole 311. An abutting block 331 extends from an end of the urging plate 33 away from the pivot portion 31.

FIG. 3 illustrates the connection member 40 comprising a stud 41 and a screw 42. The stud 41 comprises a columnar main body 411 and a head portion 412 connected to an end of the main body 411. The main body 411 axially defines a screw hole 413.

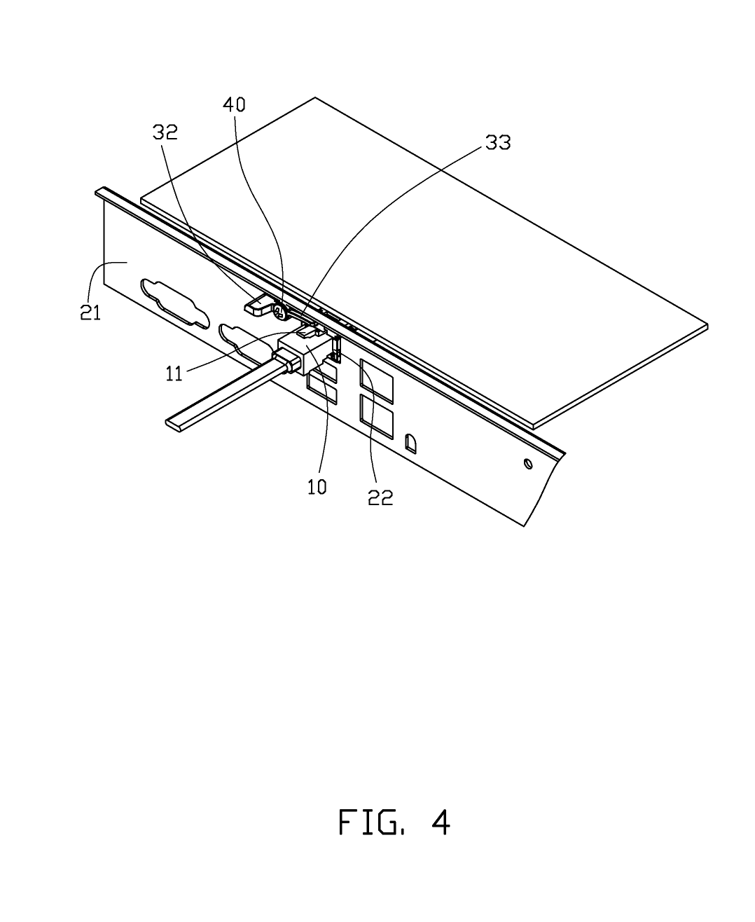

FIG. 4 illustrates that in assembly, the main body 411 of the stud 41 extends through the mounting hole 211 and is fastened to the sidewall 21. The head portion 412 of the stud 41 abuts against an inner surface of the sidewall 21. The pivot portion 31 is placed around the main body 411 by the pivot hole 311. The urging plate 33 is located above the latch 11, with the abutting block 331 facing the latch 11. The screw 42 engages in the screw hole 413 of the stud 41, so that the pivot portion 31 is sandwiched between the sidewall 21 and the screw 42, and the operation member 30 is pivotably connected to the sidewall 21.

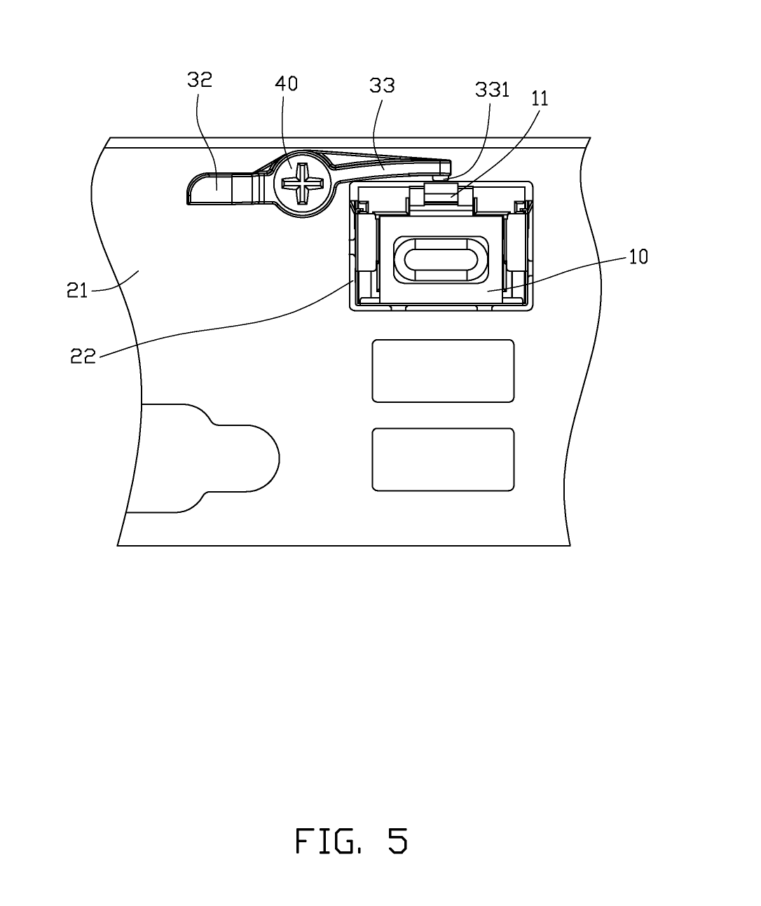

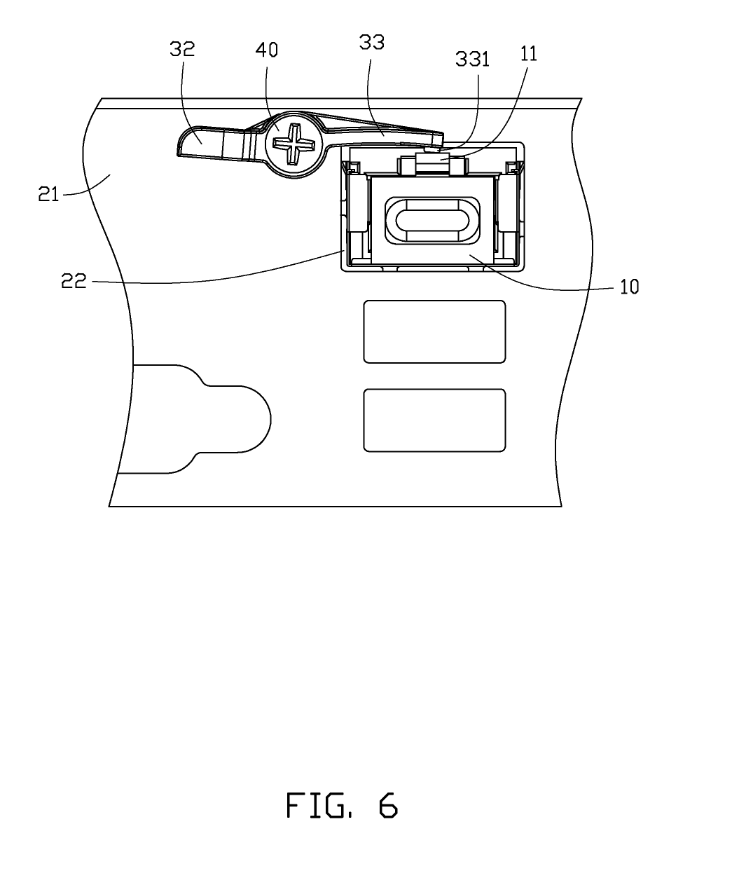

FIGS. 5 and 6 illustrate that to unplug the RJ-45 connector 10 from the connector 22, the handle 32 is manipulated up to allow the operation member 30 to rotate. The urging plate 33 is rotated down, to allow the abutting block 331 to push the latch 11 down. The latch 11 disengages from the connector 22. Thereby, the RJ-45 connector 10 can be unplugged from the connector 22.

Even though numerous characteristics and advantages of the embodiments have been set forth in the foregoing description, together with details of the structure and the functions of the embodiments, the disclosure is illustrative only, and changes may be made in details, especially in the matters of shape, size, and arrangement of parts within the principles of the embodiments to the full extent indicated by the broad general meaning of the terms in which the appended claims are expressed.

What is claimed is:

1. An assisting apparatus for unplugging a Registered Jack-45 (RJ-45) connector from a connector of an electronic device, comprising:
an operation member comprising a pivot portion pivotably connected to a sidewall of the electronic device, a handle extending from the pivot portion, and an urging plate extending from the pivot portion and located above a latch of the RJ-45 connector engaging with the connector of the electronic device;
wherein the handle is operable to rotate the operation member to cause the urging plate to push the latch down, to make the latch disengage from the connector of the electronic device.

2. The assisting apparatus of claim 1, further comprising a connection member fastened to the sidewall, the pivot portion defines a pivot hole, and the pivot portion is placed around the connection member by the pivot hole.

3. The assisting apparatus of claim 2, wherein the connection member comprises a stud fastened to the sidewall and a screw, the stud defines a screw hole, the pivot portion is placed around the stud, the screw engages in the screw hole, and the pivot portion is sandwiched between the screw and the sidewall.

4. The assisting apparatus of claim 1, wherein the pivot portion is columnar, both of the handle and the urging plate extend from a circumference of the pivot portion, and the urging plate is opposite to the handle.

5. The assisting apparatus of claim 1, wherein an abutting block extends from an end of the urging plate away from the pivot portion, for pushing the latch of the RJ-45 connector.
